(19) United States
(12) Patent Application Publication
(10) Pub. No.: US 2010/0325315 A1
(43) Pub. Date: Dec. 23, 2010

(54) Systems and methods for context-sensitive presentation of activity management data

(76) Inventor: Alon Novy, Palo Alto, CA (US)

Correspondence Address: Goodwin Procter LLP;Attn: Patent Administrator, 135 Commonwealth Drive, Menlo Park, CA, 94025-1105, US

(21) Appl. No.: 12/820,873

(22) Filed: Jun. 22, 2010

Related U.S. Application Data
(60) Provisional application No. 61/219,647, filed on Jun. 23, 2009.

(51) Int. Cl. G06F 3/00

(52) U.S. Cl. 710/18

(57) ABSTRACT

A new approach is proposed that contemplates systems and methods to support context-sensitive presentation of activity management data. Under the approach, a user's current activities are monitored and relevant data in a computer-based activity management system is retrieved if the monitored user activities meet certain criteria. A signal is then provided to the user indicative of the existence of data in the computer-based activity management system relevant to the current work of the user. Once the user indicates his/her intent to access such relevant data, that data is made accessible to the user.

### RELATED APPLICATIONS

This application claims the benefit of U.S. Provisional Patent Application No. 61/219,647, filed Jun. 23, 2009, and entitled “Systems and methods for context-sensitive presentation of activity management data,” by Alon Novy, and is fully incorporated herein by reference.

This application is related to U.S. Pat. No. 7,669,138, filed Oct. 27, 2006, and entitled “Interacting with a computer-based management system,” by Alon Novy, and is hereby incorporated herein by reference.

This application is related to U.S. patent application Ser. No. 11/457,873, filed Jul. 17, 2006, and entitled “Method and apparatus for providing structured data for free text messages,” by Alon Novy, and is hereby incorporated herein by reference.

### BACKGROUND

There exist many computer-implemented methods for managing data related to activities, including electronic to-do lists, issues and risk management systems, as well as project management and workflow management systems. Microsoft Project and Primavera and Basecamp are a few exemplary systems.

When used consistently on a daily basis to register and track the lifecycles of individual activities, issues and/or work assignments on a daily basis such systems tend to collect large quantities of activity data.

Typically, such systems provide a variety of filtering mechanisms to allow users to narrow data to a specific subset, the subset being of current relevance to the user.

Additionally, some systems provide search features wherein the system accepts user input indicative of a keyword or phrase and returns activity data that contains the relevant keyword/phrase.

While either of these solutions is suitable when the user has a specific query regarding data captured in the activity management system neither solution satisfies the very common situation wherein some data exists in the activity management system that is of current relevance to the user but the user is unaware of the existence of the data, or has forgotten about the data. Frequently users engaged in an activity will hesitate engaging the activity management system to discover whether relevant data exists because of the effort and delay caused by logging into the system and specifying a query or filter.

Thus there exists an unsatisfied need to provide a signal to the user that data relevant to the user's current work exists in the activity management system, and to allow the user to access this data easily, without interrupting the current activity.

The foregoing examples of the related art and limitations related therewith are intended to be illustrative and not exclusive. Other limitations of the related art will become apparent upon a reading of the specification and a study of the drawings.

### BRIEF DESCRIPTION OF DRAWINGS

FIG. 1 depicts an example of a system diagram to support context-sensitive presentation of activity management data.

FIG. 2 depicts a flowchart of an example of a process to support context-sensitive presentation of activity management data.

FIG. 3 depicts an example of a monitored system (an email inbox) with associated data signal provided at bottom.

### DETAILED DESCRIPTION OF EMBODIMENTS

The approach is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

A new approach is proposed that contemplates systems and methods to support context-sensitive presentation of activity management data. Under the approach, a user's current activities are monitored and relevant data in a computer-based activity management system is retrieved if the monitored user activities meet certain criteria. A signal is then provided to the user indicative of the existence of data in the computer-based activity management system relevant to the current work of the user. Once the user indicates his/her intent to access such relevant data, that data is made accessible to the user.

In some embodiments, the monitored system is a messaging system capable of sending/receiving composite data messages, where such monitoring pertains to composite data sent and received in the composite data messages. The data stored in the computer-based activity management system is collected at least partially when the user sends and receives composite data message in accordance with an activity data schema as disclosed in U.S. Pat. No. 7,669,138 and U.S. patent application Ser. No. 11/457,873. For the activity management system, the free-text portion of the composite data message is for providing activity information to at least one human recipient about an action the sender would like the recipient to carry out, and the structured data portion of the message is for providing new information and/or updates to the same and/or other activity management system(s) about the work assignment according to the activity data schema.

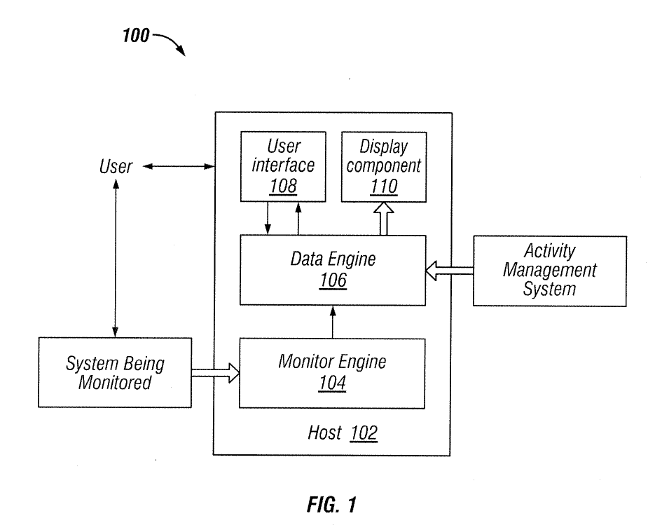

FIG. 1 depicts an example of a system diagram to support context-sensitive presentation of activity management data. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes a host (hosting device) 102 associated with a user, wherein various engines and components running on host 102 include at least a monitor engine 104, a data engine 106, a user interface 108, and a display component 110.

As used herein, the term “engine” or “component” refers to a software, firmware, hardware, or other component that is used to effectuate a purpose. The engine, component, or bridge will typically include software instructions that are stored in non-volatile memory (also referred to as secondary memory). When the software instructions are executed, at least a subset of the software instructions is loaded into memory (also referred to as primary memory) by a processor. The processor then executes the software instructions in memory. The processor may be a shared processor, a dedicated processor, or a combination of shared or dedicated processors. A typical program will include calls to hardware components (such as I/O devices), which typically requires the execution of drivers. The drivers may or may not be considered part of the engine, but the distinction is not critical.

In the example of FIG. 1, the host 102 can be a computing device, a communication device, a storage device, or any electronic device capable of running a software component. For non-limiting examples, a computing device can be but is not limited to, a laptop PC, a desktop PC, a tablet PC, an iPod, an iPad, a PDA, or a server machine. A storage device can be but is not limited to a hard disk drive, a flash memory drive, or any portable storage device. A communication device can be but is not limited to a mobile phone.

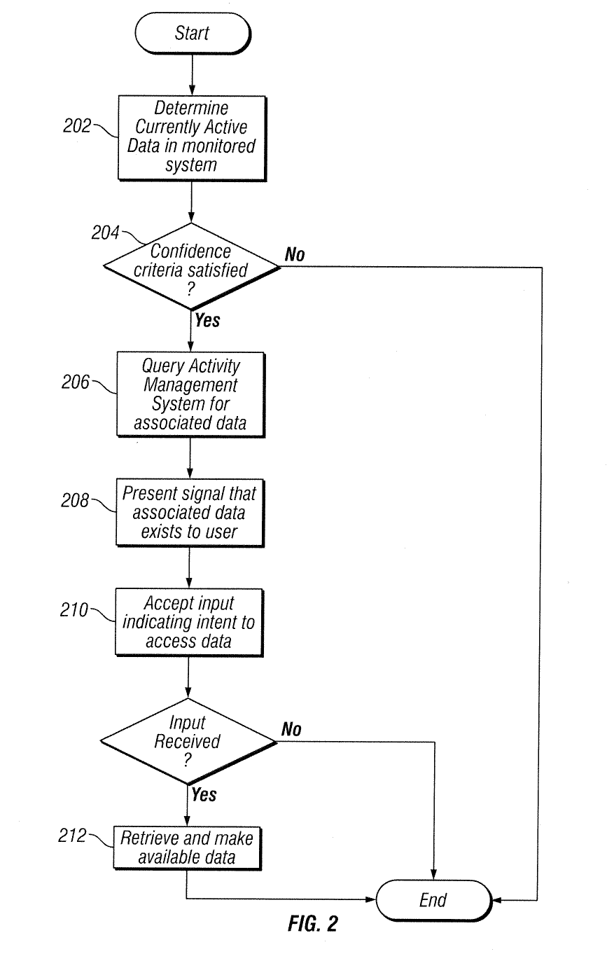

FIG. 2 depicts a flowchart of an example of a process to support communication of composite data messages in a heterogeneous messaging environment. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

In the example of FIG. 2, the flowchart 200 starts at block 202 where monitor engine 104 monitors a user's interaction with at least one of an activity management system that stores the potentially relevant activity management data and/or another system that comprises data entities that are conceptually related to data in the activity management system such as an activity database.

The flowchart 200 continues to block 204 where monitor engine 104 waits until the user selects or otherwise interacts directly or indirectly with at least one data entity (the “Currently Active Data”) for which related data may exist in the activity management system to determine whether one or more predetermined confidence criteria are satisfied or not. Here, the confidence criterion being indicative that there exists a reasonable likelihood that the Currently Active Data is the data of present interest and relevance to the user.

If one or more confidence criteria are satisfied, the flowchart 200 continues to block 206 where data engine 106 automatically queries an activity management system to determine if the activity management system contains data relevant to or associated with the Currently Active Data.

The flowchart 200 continues to block 208 where data engine 106 provides a signal to the user indicative of the existence of the associated data via user interface 108 in the case that data engine 106 determines in block 206 that associated data does exist in the activity management system.

The flowchart 200 continues to block 210 where data engine 106 optionally accepts user input indicative of the user's intent to view the associated data via user interface 108.

The flowchart 200 ends at block 212 where data engine 106 retrieves and provides the associated data to the user via display component 110 in the case the user indicates his/her intent to view the associated data.

In the example of FIG. 1, the user interface 108 running on the host 102 enables the user to interact with not only the system being monitored, but also data engine 106 and/or the monitor engine 108 in order to receive signals or alerts from and provide instructions to the engines. Such user interface can be Web-based browser for web-based messaging systems.

In the example of FIG. 1, the display component 110 of the host 102 enables the user to view not only the activities on the system being monitored, but also relevant activity data retrieved by data engine 106. Here, the display component 110 can be a monitor, a screen, or any other displaying device associated with the hosts 102 and 114 known to one skilled in the art including the entire displayable desktop of the hosts.

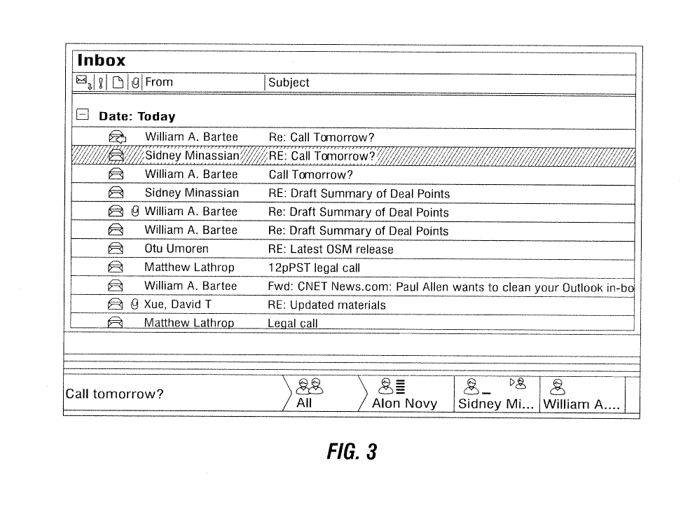

In one embodiment the system being monitored is a personal information management system, e.g., Microsoft Outlook, comprising at least one of an email client, a calendaring feature, an address book/contact list and a to-do-list. According to another embodiment, monitored system is a Customer Relationship Management system e.g., ACT and SalesForce.com. FIG. 3 depicts an example of a monitored system (an email inbox) with associated data signal provided at bottom.

According to one embodiment, the data entities for which associated data may exist in the activity management system represent physical persons. In another embodiment the data entities represent real world projects and/or initiatives. In yet another embodiment the data entities represent customers and/or sales opportunities. Additional embodiments exist with yet other data entities.

According to one embodiment the confidence criterion waited for prior to querying the activity management system is that the Currently Active Data includes the same member data entities for more than a given threshold duration, e.g., 100 ms.

In another embodiment the confidence criterion is that the user has not interacted with the system for more than a given threshold duration, e.g., 100 ms indicating that he/she may be viewing/considering the Currently Active Data. Other suitable confidence criteria exist.

According to one embodiment providing a signal indicative of the existence of associated data is a simple non-modal popup. For example, a call-out from an icon in the icon tray in Microsoft Windows stating text such as “For more information on ‘x’ click here” where ‘x’ is a descriptive label that identifies the data entity/entities associated with data in the activity management system to the user.

In one embodiment the signal is presented as part of a reserved region of the screen, for example the status bar of a window or a dedicated window.

According to another embodiment the signal includes additional information about the available associated data, for example, for each data type represented in the associated data, the signal includes the a label descriptive of the type and an indication of the number of distinct data entities of that type present in the associated data.

According to some embodiments providing the signal includes ordering the associated data using an ordering scheme, e.g., alphabetically, numerically and by priority order, where priority order is determined based on information in the activity management system.

According to some embodiments providing the signal includes grouping the associated data.

In one embodiment the Currently Active Data comprises at least one data entity that represents a person and for each person data entity in the Currently Active Data the providing the signal includes presenting the name of that person, and at least one of the number of active work assignments and b) the number of work assignments overdue and/or at risk for that that person. In another embodiment for each person the signal includes a pictorial representation of the active work assignments for that person. Additional embodiments exist that provide further information about each data entity present in the associated data.

In one embodiment determining the associated data includes acquiring from the monitored system a unique identifier for each data entity in the Currently Active Data, and using that unique identifier to look up associated data in the activity management system. In this embodiment data in the activity management system is considered to be associated if it refers to the unique identifier of a data entity in the Currently Active Data. For example the data entities represent physical persons, and the email address of each person is used as a unique identifier for the person both in the system being monitored and the activity management system. The associated data comprises the issues and tasks assigned to each person.

In another embodiment determining the associated data includes running a keyword search wherein at least one field of each data entity in the Currently Active Data provides the keyword used in the search.

In one embodiment providing the signal that associated data is available further includes providing a means of accessing the associated data, in particular a means for accepting input from the user indicative of the users intent to view and/or manipulate the associated data. For example, each data entity in the associated data is represented as a clickable icon, and by clicking an icon the user indicates his/her intent to view the associated data represented by the icon.

In the case that the user indicates intent to access the associated data, in one embodiment the data is retrieved from the activity management system and displayed to the user. Optionally in some embodiments the user is then able to manipulate and modify the associated data. In an alternate embodiment accessing the associated data further provides a means of selecting at least one summary type and/or subset of the associated data, and presenting the selected summary type and/or subset.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more hosts to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human viewer or other mechanism utilizing the results of the present invention. Such software may include, but is not limited to, device drivers, operating systems, execution environments/containers, and applications.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Particularly, while the concept “interface” is used in the embodiments of the systems and methods described above, it will be evident that such concept can be interchangeably used with equivalent software concepts such as, class, method, type, module, component, bean, module, object model, process, thread, and other suitable concepts. While the concept “component” is used in the embodiments of the systems and methods described above, it will be evident that such concept can be interchangeably used with equivalent concepts such as, class, method, type, interface, module, object model, and other suitable concepts. Embodiments were chosen and described in order to best describe the principles of the invention and its practical application, thereby enabling others skilled in the relevant art to understand the claimed subject matter, the various embodiments and with various modifications that are suited to the particular use contemplated.

1. A system, comprising:
a host associated with a user interacting with a monitored system;
a monitor engine running on the host, which in operation,
monitors a user's interaction with a system;
determines if current active data by the user with the system satisfies one or more confidence criteria;
A data engine running on the host, which in operation,
queries automatically an activity management system to determine activity management data relevant to or associated with the currently active data of the user;
provides a signal to the user indicative of the existence of the associated data.

2. A computer-implemented method, comprising:
monitoring a user's interaction with a system;
determining if current active data by the user with the system satisfies one or more confidence criteria;
querying automatically an activity management system to determine activity management data relevant to or associated with the currently active data of the user;
providing a signal to the user indicative of the existence of the associated data.

3. A machine readable medium having software instructions stored thereon that when executed cause a system to:
monitor a user's interaction with a system;
determine if current active data by the user with the system satisfies one or more confidence criteria;
query automatically an activity management system to determine for activity management data relevant to or associated with the currently active data of the user;
provide a signal to the user indicative of the existence of the associated data.
